(19) United States
(12) Patent Application Publication
(10) Pub. No.: US 2004/0265563 A1
(43) Pub. Date: Dec. 30, 2004

(54) Foam rubber extrusion molded article and process of producing the same

(76) Inventors: Takaahi Sakai, Aichi-ken (JP); Tomoaki Okita, Aichi-ken (JP)

Correspondence Address: POSZ & BETHARDS, PLC, 11250 ROGER BACON DRIVE, SUITE 10, RESTON, VA, 20190, US

(21) Appl. No.: 10/864,438

(22) Filed: Jun. 10, 2004

(30) Foreign Application Priority Data
Jun. 26, 2003 (JP) 2003-182417

(51) Int. Cl. B32B 3/26

(52) U.S. Cl. 428/315.7; 428/315.5; 428/317.9

(57) ABSTRACT

The present invention provides a foam rubber extrusion molded article capable of increasing its expansion ratio and meeting the need for less weight while keeping necessary rigidity. The foam rubber extrusion molded article includes the extrusion molded article resulting from extrusion molding of a foam rubber blend, and innumerable air bubbles present in the extrusion molded article by bubble generation are an approximate ellipsoid shape stretched in the extrusion direction. A stretching ratio of air bubbles which is the ratio of air bubble length in the extrusion direction to air bubble length in the direction perpendicular to the extrusion is 1.1 or more.

### BACKGROUND OF THE INVENTION

1. Field of the Invention

The present invention relates to a foam rubber extrusion molded article and a process of producing the same.

2. Description of Related Art

In recent years, a demand for lightening of rubber extrusion molded articles has increased. In particular, a demand from automobile manufactures for lightening of weatherstrips as a representative example of rubber extrusion molded articles is strong. Then, in the past, as discussed in Japanese laid-open patent publication numbers No.2002-274285 and No.2003-80582, techniques of designing to lighten weatherstrips as a solid rubber extrusion molded article by generating fine bubbles in them to an expansion ratio (ratio of specific gravity of the mixed compound of foam rubber to specific gravity of rubber after expansion) of from about 1.05 to 1.5 were developed.

However, in finely foam rubber extrusion molded articles, the rigidity lowers with a decrease of the rubber cross-sectional area relative to air bubbles, as compared with solid rubber extrusion molded articles. When the rigidity lowers, for example, in the case of weatherstrips, dropping from attachment portions likely occurs, or its window glass holding strength may possibly lower. For the sake of coping with the lowering of the rigidity, the following measures may be considered, but these measures encounter respective problems.

(1) To employ a rubber composition having high rigidity. In this way, though a lowering of the rigidity can be compensated for to some extent, it becomes difficult to design materials, and the costs become high. Also, since there is a limit in compensating for the lowering of the rigidity only by materials, it is impossible to set up the expansion ratio high within the foregoing range.

(2) To set up the expansion ratio low, within the foregoing range. In this way, though a lowering of the rigidity is suppressed, it is hard to meet the requirement for less weight.

### SUMMARY OF THE INVENTION

An object of the invention is to solve the foregoing problems and to provide a foam rubber extrusion molded article capable of increasing its expansion ratio and meeting the requirement for less weight while keeping necessary rigidity (especially, rigidity in the extrusion direction) and a process of producing the same.

Then, for the sake of solving the foregoing problems, the present inventors made extensive and intensive investigations. As a result, it has been found that the foregoing problems can be solved by specially modifying the shape of air bubble, leading to accomplishment of the invention. That is, the invention is concerned with a foam rubber extrusion molded article as described below in [1] and a process of producing a foam rubber extrusion molded article as described below in [2].

[1] A foam rubber extrusion molded article comprising an extrusion molded article resulting from extrusion molding of a foam rubber blend, wherein innumerable air bubbles having been made present therein by bubble generation are made to be in an approximate ellipsoid (ellipsoid of revolution (elliptical sphere)) shape stretched in the extrusion direction (based on a sphere), and a stretching ratio (ratio of an air bubble size in the extrusion direction to an air bubble size in the direction perpendicular to the extrusion) of air bubbles is 1.1 or more.

Here, it is preferable that the extrusion molded article is a finely foam rubber extrusion molded article having an expansion ratio (ratio of specific gravity of the mixed compound of foam rubber blend to specific gravity of rubber after expansion) of from 1.05 to 1.55. Also, the air bubble size in the direction perpendicular to the extrusion is not more than 110 μm in average value.

[2] A process of producing a foam rubber extrusion molded article, which comprises applying a tensile stress in the extrusion direction to an extrusion molded article resulting from extrusion molding of a foam rubber blend and prior to completion of vulcanization, thereby stretching innumerable air bubbles having been made internally present in the extruded molded article in the extrusion direction to form air bubbles into an approximate ellipsoids, and then completing vulcanization.

Here, it is preferable that the tensile stress is from 10 to 250 kPa. Also, as the foam rubber blend, raw material rubbers having a heat decomposition type blowing agent added thereto can be enumerated. In that case, it is preferred to apply the tensile stress in the expansion decomposition temperature region of the heat decomposition type blowing agent.

The respective elements of the invention including those already described will be described below in detail. Incidentally, all blending units and formulation proportions in the following description are on a weight basis unless otherwise indicated.

[Foam Rubber Blend]

The foam rubber blend that is used in the invention is a blend of a raw material rubber, a blowing agent, and optionally, subsidiary materials. Though the kind, particle size, blending ratio, and the like of each blend are not particularly limited, they can be enumerated as follows.

(1) Raw Material Rubber:

Though the raw material rubber is not particularly limited, ethylene-α-olefin based rubbers, nitrile based rubbers, and styrene based rubbers can be enumerated. Of these rubbers, as the ethylene-α-olefin based rubbers, ethylene-propylene-non-conjugated diene terpolymers (EPDM) can be suitably used, and those in which the whole or a part of the propylene component is substituted with an α-olefin having from 4 to 20 carbon atoms can also be suitably used. In general, the ethylene content is from 55 to 75% by weight. Examples of the non-conjugated diene that can be suitably used include 5-ethylidene-2-norbornene (ENB), dicyclopentadiene (DCPD), and 1,4-hexadiene (1,4-HD). The content of the non-conjugated diene is adjusted such that the iodine value falls within the range of from 5 to 25. As EPDM, oil extended types resulting from addition of from 10 to 40 parts of a process oil to 100 parts of the raw material rubber (EPDM) at the time of polymer production may be used. Further, polymer alloys prepared by previously dry blending the oil extended EPDM with from 5 to 50 phr, preferably from 10 to 40 phr, and more preferably from 15 to 30 phr of crystalline polyethylene (crystalline PE) described later may be used. In this case, it becomes possible to improve the surface skin (surface roughness).

And, a preferred embodiment of the raw material rubber is a polymer blend of EPDM with an ethylene-α-olefin-non-conjugated diene based rubber other than EPDM (the a-olefin has from 4 to 8 carbon atoms, and preferably from 4 to 5 carbon atoms), with the blending ratio of the former to the latter (weight ratio) being from 95/5 to 50/50, and preferably from 90/10 to 70/30, and as the latter, a generally useful ethylene-butene-non-conjugated diene rubber (EBDM) can be suitably used. At this time, the rubber blend has a Mooney viscosity, Vm (according to JIS K6300) of from 45 to 65, and preferably from 50 to 60 from the standpoint of extrusion processability or the like, an aspect of which is, however, not required. By blending EPDM with EBDM, an increase of relative abrasion resistance can be expected. When the viscosity of the blended rubber falls within the foregoing range, it becomes easy to control the air bubble size to a prescribed value or less.

(2) Blowing Agent:

Though the blowing agent is not particularly limited, organic heat decomposition type blowing agents, inorganic heat decomposition type blowing agents, organic reaction type blowing agents, inorganic reaction type blowing agents, organic physical blowing agents, and inorganic physical blowing agents can be enumerated. Of these blowing agents, the heat decomposition type blowing agent varies depending upon the vulcanization temperature and vulcanization method and is not particularly limited. Examples thereof include 4,4′-oxybisbenzenesulfonyl hydrazide (OBSH), azodicarbonamide (ADCA), dinitrosopentamethylenetetramine (N,N′-DPT), p-toluenesulfonyl hydrazide (TSH), azobisisobutyronitrile (AZDN), and combinations thereof with an auxiliary. Of these, those having a heat decomposition temperature of from 150 to 170° C. are preferable, and representative examples thereof include OBSH.

It is preferable that the heat decomposition type blowing agent has a mean particle size of not more than 8 μm (preferably not more than 4 μm) and is blended in the rubber blend in the form in which it is contained in a raw material rubber master batch or in the form in which it is supported on an inorganic powder. This is in order that dispersibility of the blowing agent is good so that the foam bodies having a small air bubble size and a prescribed expansion ratio are readily obtained. At this time, the blending amount of the blowing agent varies depending upon the required expansion ratio, the skin layer thickness, and the kind of blowing agent but may be properly set up in the range of from 0.2 to 1.5 phr, and preferably from 0.3 to 1.0 phr.

In the case where the heat decomposition type blowing agent is blended in the form of an inorganic supported blowing agent supported on an inorganic powder (inorganic carrier), the inorganic powder may be set up so as to have a particle size of not more than about 9 μm (preferably from 0.1 to 7 μm, and more preferably from 0.1 to 2 μm). Though it is possible to blend the inorganic supported blowing agent in the form of a master batch, the inorganic supported blowing agent has dispersibility itself, and it is not required to deliberately blend the inorganic supported blowing agent in the form of a master batch. The reason why the heat decomposition type blowing agent is blended as an inorganic supported blowing agent resides in not only making it easy to control the specific gravity, i.e., expansion ratio, of a vulcanized material but also uniformly dispersing the blowing agent and stabilizing the degree of expansion of each part. At this time, the content of the heat decomposition type blowing agent in the inorganic supported blowing agent may be set up at from 2 to 50% by weight, and preferably from 5 to 25% by weight.

The inorganic powder is not particularly limited, but examples thereof include inorganic fillers (for example, finely divided talc, precipitated calcium carbonate light, calcium carbonate heavy, magnesium carbonate, zinc oxide, wollastonite, silica, clay, talc, and diatomaceous earth) and fillers resulting from surface treatment of such an inorganic filler with a silane coupling agent. Of these, talc having a lubricating action, especially finely divided talc, is preferable. The finely divided talc to be used has a mean particle size of from 0.1 to 1 μm, and preferably from 0.3 to 0.7 μm. Also, in the case of precipitated calcium carbonate light, it is desired to use one having a mean particle size of from 0.2 to 4 μm, and preferably from 0.5 to 2 μm. In the case of calcium carbonate heavy, it is desired to use one having a mean particle size of from 0.5 to 9 μm, and preferably from 3 to 7 μm.

Also, though the particle size of each of the heat decomposition type blowing agent and the inorganic powder may be controlled such that the mean particle size ultimately becomes the foregoing numerical value or less, it is desired that each mean particle size is controlled at the foregoing numerical value or less from the beginning of mixing. This is because in particular, the heat decomposition type blowing agent may possibly cause partial decomposition by shear heat. Also, though a lower limit of the mean particle size of each of the heat decomposition type blowing agent and the inorganic powder is not particularly limited, it may be set up at 0.1 μm for the inorganic powder and 1 μm for the heat decomposition type blowing agent, respectively from the viewpoint of handling and mixing properties.

For example, the inorganic supported blowing agent can be prepared through homogenization by means of simple mixing using a super mixer, etc. In the case where it is intended to further increase homogeneity of the blowing agent, the preparation can be carried out by using a mechanical particle composite processing method (see the paragraph of “Composite Processing and Function-addition Techniques of Powder Materials” on pages 27 to 33 of Kogyo Zairyo, December 1993), or by an emulsification and suspension method utilizing liquid phase reaction, a sol-gel method, a doping method, a chemical vapor deposition method (CVD), or the like. As a specific example of devices for this mechanical particle composite processing, a device described in JP-A-63-42728 can be suitably employed.

(3) Subsidiary Materials:

Subsidiary materials such as reinforcing fillers (carbon black and white carbon), plasticizers, lubricants, and vulcanization based chemicals are blended, as the need arises.

(4) Vulcanization Rate:

The foam rubber blend may be a blending formulation exhibiting a vulcanization rate, T₁₀ of from 0.6 to 1.8 minutes (preferably from 0.8 to 1.4 minutes) at 170° C. (according to JIS K6300). The vulcanization rate is adjusted through a combination with a generally used vulcanization accelerator.

[Expansion Ratio, Air Bubble Size and Stretching Ratio]

Though the expansion ratio is not particularly limited, the invention is especially effective with fine bubbles within the range of from 1.05 to 1.55 in terms of expansion ratio. Above all, the expansion ratio is preferably in the range of from 1.15 to 1.50, and more preferably from 1.15 to 1.30. As described previously, the air bubbles are an approximate ellipsoid stretched in the extrusion direction, and the stretching ratio (ratio of an air bubble size in the extrusion direction to an air bubble size in the direction perpendicular to the extrusion) is 1.1 or more.

As described previously, the stretching ratio (ratio of an air bubble size in the extrusion direction to an air bubble size in the direction perpendicular to the extrusion) is required to be 1.1 or more. The stretching ratio is preferably from 1.15 to 1.55, and more preferably from 1.2 to 1.55. When the stretching ratio is less than 1.1, the air bubbles are substantially equal to the conventional spherical air bubbles so that it is difficult to increase the expansion ratio while keeping the rigidity in the extrusion direction. On the other hand, a stretching ratio exceeding 1.60 is itself difficult to realize.

The air bubble size is not particularly limited. However, in the case of the foregoing fine expansion, the air bubble size in the direction perpendicular to the extrusion is not more than 110 μm, preferably from 40 to 100 μm, and more preferably from 50 to 95 μm.

[Extrusion Molding]

The foam rubber blend is extrusion molded using an extruder for rubber and subsequently vulcanized. At this time, though the extrusion rate is not particularly limited, it may be set up at from 8 to 25 m/min, and preferably from 12 to 18 m/min.

[Vulcanization]

The vulcanization method is not particularly limited. For example, a microwave vulcanization device and a hot air vulcanization device, or two hot air vulcanization devices having a different condition for setting up the temperature, may be provided in order, or a microwave vulcanization device may be interposed between hot air vulcanization devices. Though the vulcanization condition is not particularly limited, it may be set up at from 180 to 240° C. for from 2 to 10 minutes, and preferably at from 210 to 230° C. for from 3 to 6 minutes.

[Tensile Stress in the Extrusion Direction]

The tensile stress in the extrusion direction to be applied to the extrusion molded article may be set up at from 10 to 250 kPa, and preferably from 30 to 140 kPa. Though the method of applying a tensile stress is not particularly limited, the following methods can be enumerated.

(1) A method in which after extrusion molding, when the extrusion molded article comes out from the vulcanization device, it is drawn using a wire, etc. Concretely, a method in which the extrusion molded article is gripped by a clip, etc. and drawn by a wire, etc. can be enumerated.

(2) A method in which after extrusion molding, when the extrusion molded article comes out from the vulcanization device (or is in the middle of the vulcanization device), it is drawn while being rapidly sent out by rotating rollers. Concretely, the extrusion molded article is rapidly sent out by rotating rollers gripping the extrusion molded article and rotating at a rate equal to the sum of the extrusion rate of the extrusion molded article, the increase of the speed caused by the bubble expansion, and a rate which will cause the above tensile stress.

Incidentally, in the case where a heat decomposition type blowing agent is used as the blowing agent, the tensile stress may be applied in the expansion decomposition temperature region of the heat decomposition type blowing agent. For example, in the case where OBSH is used, the tensile stress may be applied when the OBSH is from 150 to 200° C.

### BRIEF DESCRIPTION OF THE DRAWINGS

FIG. 1 is a perspective view of a weatherstrip for an automobile of the embodiment according to the invention.

FIG. 2 is a schematic view showing a plate-like extrusion molded article of the embodiment according to the invention and a process of producing the same.

FIG. 3A is a perspective view of the foregoing plate-like extrusion molded article.

FIG. 3B is an explanatory view of the mechanism wherein air bubbles of an approximate ellipsoid are generated.

FIG. 4 is a graph showing the relationship between the stretching ratio of an air bubble and a tensile stress in the foregoing plate-like extrusion molded article.

FIG. 5 is a graph showing the relationship between a Young's modulus in the extrusion direction and a stretching ratio of an air bubble in the foregoing plate-like extrusion molded article.

### DETAILED DESCRIPTION OF THE PREFERRED EMBODIMENTS

(1) Preparation of Foam Rubber Blend:

A foam rubber blend was kneaded and prepared according to a blending formulation shown in Table 1 by means of a usual closed type kneading machine and roll kneading. As EPDM, a type having an ethylene content of 62% and an iodine value of 12 and containing ethylidene norbornene as the third component, to which 10 phr of a paraffinic oil and 20 phr of PE had been added, was used. The blowing agent is a 40% master batch of OBSH (4 μm).

TABLE 1

| Raw material | EPDM | 110 |
|---|---|---|
| rubber | EBDM | 7.5 |
| FEF Carbon black | | 185 |
| Paraffinic process oil | | 85 |
| Calcium carbonate | | 30 |
| Active zinc oxide | | 3 |
| Dehydrating agent (Calcium oxide) | | 5 |
| Processing aid | | 10 |
| Vulcanizing agent (Sulfur) | | 1.2 |
| Valcanization | Zinc dithiocarbamate base | 1 |
| accelerator | Thiuram base | 0.5 |
| | Sulfenamide base | 1 |
| | Morpholine base | 1 |

| | |
|---|---|
| Blowing agent (Net amount) | 1.25 (0.5) |

(2-1) Production of Plate-Like Extrusion Molded Article:

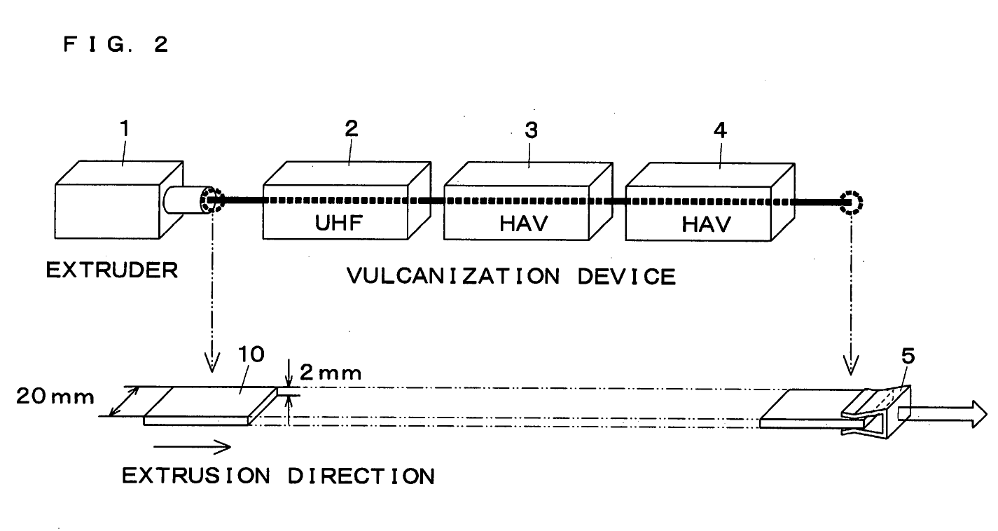

As shown in FIG. 2, the foam rubber blend prepared above in (1) was extrusion molded into a plate-like extrusion molded article 10 using an extruder 1 (for example, cylinder diameter: 90 mmφ, L/D=22). The plate-like extrusion molded article 10 has a plate width of 20 mm and a plate thickness of 2 mm at an extrusion rate of 12 m/min. The continuous plate-like extrusion molded article 10 having come out from the extruder 1 was successively passed through a microwave (UHF) vulcanization device 2, a first hot air vulcanization (HAV) device 3, and a second hot air vulcanization (HAV) device 4. When the plate-like extrusion molded article 10 came out from the HAV vulcanization device 4, it was gripped by a clip 5 and given a tensile stress by continuously drawing by a wire at an arbitrary load. When the plate-like extrusion molded article 10 comes out from the HAV vulcanization device 4, vulcanization is substantially completed. Also, since OBSH as the heat decomposition type blowing agent is decomposed by heat at the time of vulcanization to generate a decomposed gas, innumerable air bubbles are made internally present in the plate-like extrusion molded article 10.

The resulting plate-like extrusion molded articles when the tensile stress was 12, 60 and 195 kPa were designated as Examples 1, 2 and 3, respectively. Also, a plate-like extrusion molded article prepared without applying a tensile stress was designated as Comparative Example 1, and when the tensile stress was 5 kPa and 250 kPa, the resulting plate-like extrusion molded articles were designated as Comparative Examples 2 and 3, respectively. The UHF vulcanization device 2 was adjusted so as to have an output of about 4 kW, and a time of passing through this device at the foregoing extrusion rate was about 30 seconds. The first HAV vulcanization device 3 was adjusted so as to have a hot air temperature of about 220° C., and a time of passing through this device at the foregoing extrusion rate was about 100 seconds. The second HAV vulcanization device 4 was adjusted so as to have a hot air temperature of about 220° C., and a time of passing through this device at the foregoing extrusion rate was about 100 seconds.

(2-2) Measurement of Plate-Like Extrusion Molded Article:

With respect to the respective plate-like extrusion molded articles 10 of Examples 1, 2 and 3 and Comparative Examples 1 and 2 obtained above in (2-1), the following items (1), (2) and (3) were measured. The plate-like extrusion molded article 10 of Comparative Example 3 could not be measured because it was broken in the middle of the vulcanization devices 2, 3 and 4 due to an excess of the tensile stress.

(1) Expansion Ratio:

The ratio of specific gravity of the mixed compound of the foam rubber blend to specific gravity of the plate-like extrusion molded article 10 was determined and defined as the expansion ratio. The specific gravity was measured according to the underwater displacement method (JIS K6301).

(2) Air Bubble Size and Stretching Ratio:

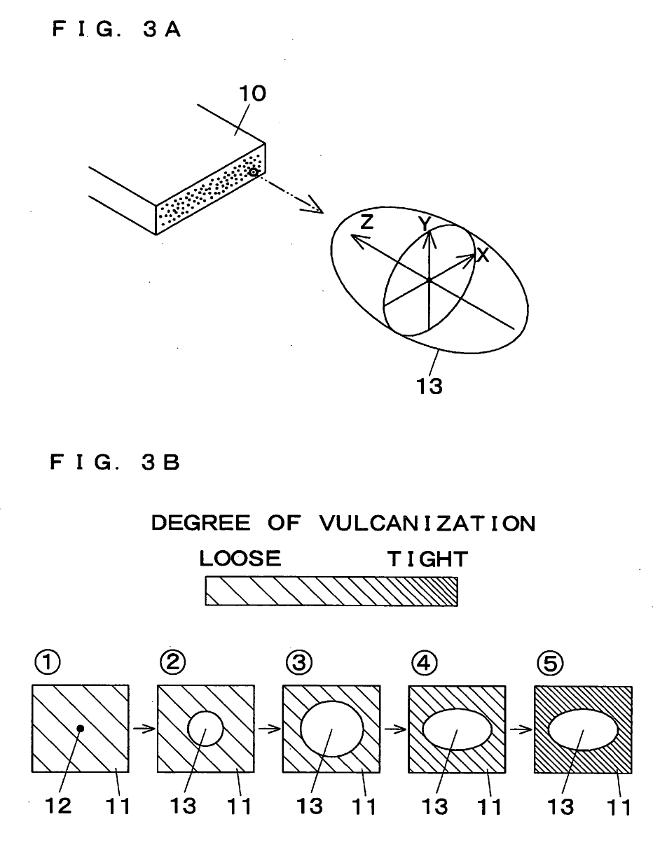

With respect to microscopically enlarged 50 or more air bubbles in the approximately central portion (internal portion) in the plate thickness direction, the air bubble size was measured. As shown in FIG. 3A, the air bubble size of an air bubble 13 in the direction perpendicular to the extrusion (the plate width direction is defined as an X-direction, and the plate thickness direction is defined as a Y-direction) was measured. As a result, in any of Examples 1, 2 and 3 and Comparative Examples 1 and 2, there was not recognized a meaningful difference between the X-direction and the Y-direction (that is, the X-Y cross-section of the air bubble was close to a true circle). Next, the air bubble size in the extrusion direction (Z-direction) was measured. As a result, in Examples 1, 2 and 3, the air bubble size was clearly longer than that in the direction perpendicular to the extrusion (that is, the Z-Y cross-section of the air bubble was an approximate ellipse in which the air bubble size in the Z-direction was long). Namely, the air bubble 13 was an approximate ellipsoid stretched long in the extrusion direction. In this way, the air bubble size in the direction perpendicular to the extrusion and the air bubble size in the extrusion direction were measured, the respective average values were determined, and a stretching ratio in the extrusion direction (ratio of the air bubble size in the extrusion direction to the air bubble size in the direction perpendicular to the extrusion) was then calculated.

(3) Young's Modulus:

A tensile test was carried out at a rate of 50 mm/min according to JIS K6251 to measure a tensile stress at the time of stretching of 25%, from which was then determined a Young's modulus.

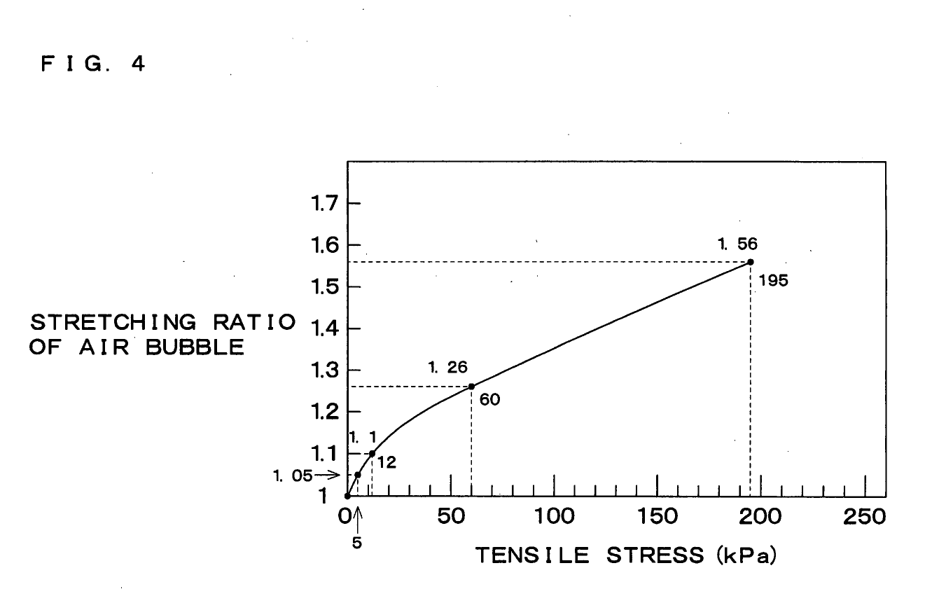

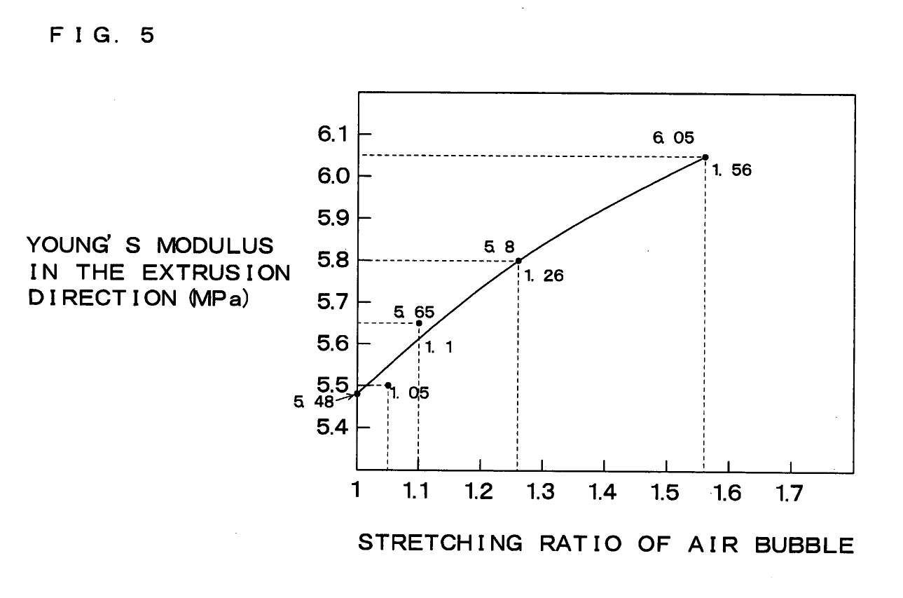

The measurement results are shown in Table 2. Also, in particular, the relationship between the stretching ratio of air bubble and the tensile stress is shown in FIG. 4, and the relationship between the Young's modulus in the extrusion direction and the stretching ratio of air bubble is shown in FIG. 5.

TABLE 2

| | Comparative | | | | | Comparative |
|---|---|---|---|---|---|---|
| | Example | | Example | | | Example |
| | 1 | 2 | 1 | 2 | 3 | 3 |
| Tensile stress at the | 0 | 5 | 12 | 60 | 195 | 250 |
| time of molding (kPa) | (0) | (20) | (50) | (250) | (800) | (1000) |
| (Load(gf)) | | | | | | |
| Expansion ratio | 1.20 | 1.20 | 1.20 | 1.20 | 1.20 | |
| Air bubble size in the | 61.9 | 61.1 | 59.9 | 57.4 | 53.5 | |
| direction perpendicular | | | | | | |
| to the extrusion (μm) | | | | | | |
| Air bubble size in the | 62.0 | 64.1 | 66.3 | 72.3 | 83.4 | |
| extrusion direction | | | | | | |
| (μm) | | | | | | |
| Stretching ratio of air | 1.00 | 1.05 | 1.10 | 1.26 | 1.56 | |
| bubble | | | | | | |
| Young's modulus in | 5.48 | 5.50 | 5.65 | 5.80 | 6.05 | |
| the extrusion direction | | | | | | |
| (Mpa) | | | | | | |

The mechanism in which air bubbles of an approximate ellipsoid stretched long in the extrusion direction are generated is considered as follows. FIG. 3B schematically shows a heat decomposition type blowing agent 12 or air bubble 13 in a rubber blend 11. The degree of vulcanization of the rubber blend is expressed by width and narrowness of intervals of given hatchings. As shown in (1) to (2) of this drawing, first of all, when vulcanization starts by heat at the time of vulcanization, the heat decomposition type blowing agent 12 is decomposed to generate a decomposed gas, thereby forming the air bubble 13 close to a true sphere. Then, as shown in (2) to (4) of the drawing, when a tensile stress is applied in the extrusion direction during the progress or after completion of decomposition reaction of the heat decomposition type blowing agent 12, which advances with the progress of vulcanization, the air bubble 13 is deformed into the extrusion direction so that it becomes an approximate ellipsoid. When the vulcanization further proceeds, it is considered that the shape of the air bubble 13 is solidified as shown in (5) of the drawing.

As shown in Table 2 and FIG. 4, in Comparative Example 1 and Examples 1, 2 and 3, the larger the tensile stress, the larger the stretching ratio of the air bubble was. On the other hand, as described previously, Comparative Example 3 in which the tensile stress was in excess was broken. Also, as shown in Table 2 and FIG. 5, in Examples 1, 2 and 3, even though the expansion ratio was equivalent to that in Comparative Example 1, the Young's modulus in the extrusion direction was larger than that in Comparative Example 1. When the stretching ratio was large, an increase of the Young's modulus was remarkable. Accordingly, in Examples 1, 2 and 3, it was noted that even when setting of the blowing agent and the like was changed so as to increase the expansion ratio for the purpose of achieving less weight, The Young's modulus equivalent to that in Comparative Example 1 could be kept. On the other hand, in Comparative Example 2, there was not recognized a meaningful difference with respect to the Young's modulus from that in Comparative Example 1.

In this way, in Examples 1, 2 and 3, the Young's modulus in the extrusion direction increased, whereas the Young's modulus in the direction perpendicular to the extrusion tended to become slightly low. However, in extrusion molded articles, if a Young's modulus in the extrusion direction is high, even when a Young's modulus in the direction perpendicular to the extrusion becomes slightly low, it is possible to increase the required rigidity as a whole. For example, in weatherstrips described below, it is possible to increase the rigidity effective for preventing occurrence of dropping of window glass from attachment portions and for preventing a lowering of the glass holding force. If only the required rigidity need be maintained, it is possible to design a weight reduction by increasing the expansion ratio.

(3-1) Production of Weatherstrip:

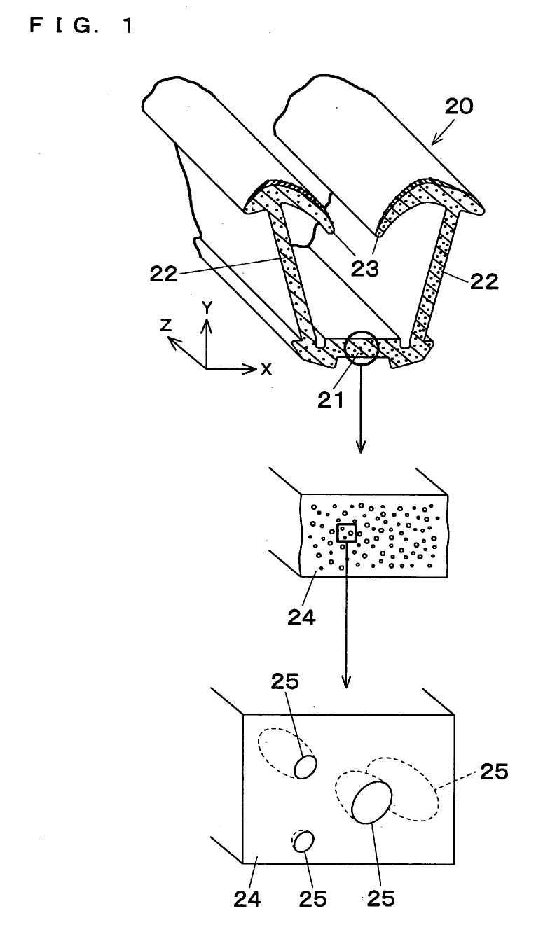

Next, as in the case of the foregoing plate-like extrusion molded article 10, the foam rubber blend prepared above in (1) was extrusion molded into a weatherstrip 20 for an automobile having the cross-sectional shape (thickness: 2 to 5 mm) shown in FIG. 1. The weatherstrip 20 was then passed through the respective vulcanization devices 2, 3 and 4. When the weatherstrip 20 came out from the vulcanization device 4, it was drawn so as to be given a tensile stress of 55 kPa. This weatherstrip 20 is a glass run and is provided with a basal portion 21 with which the end face of a glass comes into slidable contact, a pair of side wall portions 22, and a pair of seal lip portions 23 with which the both surfaces of the glass come into slidable contact.

(3-2) Measurement of Weatherstrip:

With respect to the weatherstrip 20 obtained above in (3-1), its expansion ratio was measured in the same manner as in the case of the plate-like extrusion molded article 10. As a result, it was found to be 1.20. Also, with respect to the air bubble size and stretching ratio of air bubbles 25 having been made internally present in a rubber blend 24, not only air bubbles in the approximately central portion (internal portion) in the plate thickness direction but also those in the vicinity of the surface were measured. As a result, as shown in Table 3, the air bubble size in the vicinity of the surface was smaller than that in the internal portion, but the air bubbles in the vicinity of the surface were stretched in the extrusion direction.

TABLE 3

| | Internal | Vicinity of |
|---|---|---|
| | portion | the surface |
| Air bubble size in the | 57.8 | 42.4 |
| direction perpendicular | | |
| to the extrusion (μm) | | |
| Air bubble size in the | 70.0 | 55.1 |
| extrusion direction (μm) | | |
| Stretching ratio of air | 1.21 | 1.30 |
| bubble | | |

Incidentally, it should not be construed that the invention is limited to the foregoing embodiments, but it is also possible to properly make changes various changes for materialization so far as such does not fall outside the gist of the invention.

As described previously in detail, in accordance with the foam rubber extrusion molded article and the process of producing the same according to the invention, it is possible to increase expansion ratio and meet the need for less weight while keeping necessary rigidity.

What is claimed is:

1. A foam rubber extrusion molded article comprising:
an extrusion molded article resulting from extrusion molding of a foam rubber blend,
wherein innumerable air bubbles present in said extrusion molded article by bubble generation are an approximate ellipsoid shape stretched in the extrusion direction, and
wherein a stretching ratio of said air bubbles which is the ratio of air bubble length in the extrusion direction to air bubble length in the direction perpendicular to the extrusion is 1.1 or more.

2. The foam rubber extrusion molded article according to claim 1, which is a fine bubble foam rubber extrusion molded article having an expansion ratio of from 1.05 to 1.55.

3. The foam rubber extrusion molded article according to claim 1,
wherein an average air bubble size in the direction perpendicular to the extrusion is not more than 110 μm.

4. The foam rubber extrusion molded article according to claim 2,
wherein an average air bubble size in the direction perpendicular to the extrusion is not more than 110 μm.

5. A process of producing a foam rubber extrusion molded article comprising:
applying a tensile stress in an extrusion direction to an extrusion molded article resulting from extrusion molding of a foam rubber blend and prior to completion of vulcanization, thereby stretching innumerable air bubbles present in said extrusion molded article in the extrusion direction to form said air bubbles into an approximate ellipsoid shape, and then completing vulcanization.

6. The process of producing a foam rubber extrusion molded article according to claim 5,
wherein said tensile stress is from 10 to 250 kPa.

7. The process of producing a foam rubber extrusion molded article according to claim 5,
wherein said foam rubber blend is a foam rubber blend comprising a raw material rubber having a heat decomposition type blowing agent added thereto.

8. The process of producing a foam rubber extrusion molded article according to claim 6,
wherein said foam rubber blend is a foam rubber blend comprising a raw material rubber having a heat decomposition type blowing agent added thereto.

9. The process of producing a foam rubber extrusion molded article according to claim 7,
wherein the tensile stress is applied when the foam rubber is in the expansion decomposition temperature region of said heat decomposition type blowing agent.

10. The process of producing a foam rubber extrusion molded article according to claim 8,
wherein the tensile stress is applied when the foam rubber is in the expansion decomposition temperature region of said heat decomposition type blowing agent.
